(19) United States
(12) Patent Application Publication
(10) Pub. No.: US 2005/0127836 A1
(43) Pub. Date: Jun. 16, 2005

(54) Incandescent lamp having an activating effect

(75) Inventors: Carsten Plumeyer, Martinsried (DE); Yannick Scheyer, Strasbourg (FR)

Correspondence Address: OSRAM SYLVANIA INC, 100 ENDICOTT STREET, DANVERS, MA, 01923, US

(73) Assignee: PATENT-TREUHAND-GESELLSCHAFT FUR ELECKTRISCHE GLUHLAMPEN MBH, MUNCHEN (DE)

(21) Appl. No.: 11/009,140

(22) Filed: Dec. 13, 2004

(30) Foreign Application Priority Data
Dec. 12, 2003 (DE) 10358676.8

(51) Int. Cl. H01K 1/26; H01K 1/42; H01K 1/50; H01K 1/66

(52) U.S. Cl. 313/580

(57) ABSTRACT

The invention relates to an incandescent lamp having an increased activating effect, in which a greater emission in absolute terms is achieved in the spectral range having a circadian effect owing to spectral filtering, on the one hand, and measures for compensating for the luminous flux losses, on the other hand, given a lamp output power and luminous efficiency which overall remain substantially the same. This spectral range has physiological effects on the human body.

### TECHNICAL FIELD

The present invention relates to an incandescent lamp.

### BACKGROUND ART

Incandescent lamps have long been known per se. They generate light by means of thermal emission, generally by means of an incandescent element, for example a metal filament. This is the historically oldest design for electric lamps which is nevertheless still of considerable importance partly owing to the low lamp costs, partly owing to the continuous emission spectrum in comparison with discharge lamps, and occasionally for reasons of physical size or for other reasons.

In principle, incandescent lamps have relatively good color rendering owing to the continuous emission spectrum, but are subject to limitations as regards the color temperature, i.e. specifically as regards the “warmth” or, in contrast, the “whiteness” of the light. The life of incandescent lamps is generally limited by the incandescent filament, from which metal is removed by vaporization, which in the end leads to filament breakages. Various technologies have been developed to reduce this problem. In particular, mention may be made here of the halogen cycle process in the halogen incandescent lamps which is used to recycle the vaporized metal to the incandescent filament.

However, in principle it is still the case with incandescent lamps, even with halogen incandescent lamps, that an increase in the color temperature, in favor of a whiter light, or an increase in the luminous efficiency, i.e. the luminous flux (in the unit lumens (lm)) per unit of electrical output power used (in watts (W)), by means of the electrical design results in reductions in life owing to the higher incandescent filament temperatures which are necessarily associated therewith.

The known measures, such as the use of different gas compositions in (conventional) incandescent lamps, the halogen cycle process in halogen incandescent lamps and other steps known per se, are in this case, on the other hand, in constant conflict with cost considerations. As a result of such measures, longer-life or better (in terms of luminous efficiency) incandescent lamps are therefore in principle more expensive, with the result that it is primarily special application fields in which such measures are taken. For example, halogen incandescent lamps are used in particular when the color rendering and the whiteness of the light are of importance. Conventional Kr incandescent lamps, for example, are still offered more as a niche product owing to their higher costs.

Irrespective of this, in recent years it has been shown in medical investigations that the visible part of the electromagnetic spectrum also has physiological effects on the human organism. In particular, it has been shown that the human eye contains receptors which interact with the control of the hormonal balance of the sleeping hormone melatonin. These receptors are primarily sensitive in the blue range, the maximum sensitivity being approximately in the range from 450-470 nm.

### DISCLOSURE OF THE INVENTION

The invention is based on the technical problem of specifying an incandescent lamp having improved properties.

The invention is based on an incandescent lamp which is designed such that it achieves a minimum rated luminous efficiency, listed below, dependent on the lamp output power:

| Lamp output powers/W | Luminous efficiency/lm/W |
|---|---|
| 5-20 | 5.7 |
| 20-33 | 7.2 |
| 33-50 | 9.2 |
| 50-68 | 10.1 |
| 68-88 | 11.8 |
| 88-125 | 12.6 |
| 125-175 | 13.5 |
| 175-250 | 14.2 |
| 250-400 | 14.4 |
| ≧400 | 15.8 |

This incandescent lamp is characterized by a color filter for filtering the incandescent lamp light and for increasing the circadian factor to at least 0.38.

Preferably used as a basis in the list above are in each case 2% higher and, particularly preferably, 4% higher luminous efficiencies. The circadian factor is preferably at least 0.39 and particularly preferably at least 0.40.

The basic idea of the invention is to provide an increased activating effect on the human organism in the case of an incandescent lamp in comparison with a conventional incandescent lamp which is comparable in terms of the electrical data. This effect should take place by increasing the relevant blue component, which in this case is defined by means of the so-called circadian factor used as the technical variable. This circadian factor describes the ratio of the activating component, determined by an assumed sensitivity curve, of the radiant power to the total luminous flux. In this case, the luminous flux is the radiant power evaluated using the spectral visual sensitivity (as regards the normal impression of brightness). Of concern here is thus the ratio of two integrals over the radiant power, in one case with the weighting function of the circadian effect on the activating light receptors, and in the other case (in the case of luminous flux) with the spectral brightness sensitivity of the human eye.

The term “circadian factor” and also the term “luminous flux” are technical variables used per se. Reference is made to the definition in the publication by Prof. Dietrich Gall in the journal “LICHT” [LIGHT], edition 11-12, 2002. However, it should be noted that the basic physiological mechanisms depend on various parameters, i.e., for example, the dark-adapted eye reacts differently from the light-adapted eye. There are also different economic viewpoints regarding details on the correct circadian efficiency distribution in the blue spectrum, in particular depending on the light/dark adaptation, but these will not be explained in further detail here.

The invention is demarcated by the fact that the circadian factor has a value of at least 0.38, preferably 0.39 and particularly preferably at least 0.40. This is achieved by a color filter which does not absorb the relevant blue component or absorbs it more weakly than other spectral components. The color filter thus generally absorbs predominantly in the yellow range. However, the invention is not restricted to this filter effect, which in fact does not increase the activating component in the emission spectrum at all in absolute terms. Rather, according to the invention at the same time, a luminous efficiency (i.e. luminous flux per unit of output power used) is achieved which is at least comparable with that of a conventional, comparable incandescent lamp, as is specified above. In this case, a differentiation has been carried out based on the lamp output power (the so-called wattages) which also corresponds in conventional incandescent lamps to the technical facts and boundary conditions. For the specified limit values, for example 33 W, in each case the higher value shall be valid.

Various measures are known to those skilled in the art for increasing the luminous efficiency which are in principle possible. For example, it may be expedient to use a filling gas, in particular Ar, N₂, Kr and Xe, Kr and Xe being particularly preferred. In particular, mixtures come into consideration which on the one hand, for reasons of electrode short-circuit strength, contain some N₂ and, on the other hand, contain a relatively large amount of Kr. Some Ar may also be provided. The Kr content is preferably between 60 and 97 vol. %, in particular over 70 or 75 vol. % and, in particular, below 90 or 85 vol. %. The N₂ content in the filling gas is preferably between 3 and 40 vol. %, inclusive, and preferably below 5 vol. %. The numerical values are in each case inclusive.

The Ar content in turn is preferably at most 37 vol. %.

Further possibilities relate to increased filling pressures of such or other gas fillings in the incandescent lamp, specifically preferably over 850, especially over 920 and advantageously over 980 mbar at room temperature.

The gas fillings reduce the metal vaporization of the incandescent filament resulting from impacts, specifically, on the one hand, depending on the atomic or molecular mass, and, on the other hand, also depending on the pressure.

A further preferred possibility consists in using a halogen incandescent lamp. Although, on the one hand, this increases costs, on the other hand, the luminous efficiency or life can be considerably increased in comparison with the fillings described above. In particular, even using a conventional type of incandescent lamp, a corresponding, smaller halogen incandescent lamp can be installed, i.e. a so-called high-volt halogen lamp within an envelope corresponding to that of a conventional incandescent lamp. On the one hand, the halogen incandescent lamp thus has unique technical advantages, and, on the other hand, an incandescent lamp without a halogen additive likewise has its own advantages, namely a technically more simple design and reduced costs.

Incidentally, the halogen additive does not rule out further gas additives; in particular, an additional use of Xe may be advantageous in a halogen lamp.

A further measure is an infrared-reflecting device in the incandescent lamp, for example a coating of the bulb or envelope. This increases the incandescent filament temperature owing to some of the radiated IR output power being reflected back.

Finally, as has already been explained initially, in the case of incandescent lamps the increase in the luminous efficiency owing to the electrical dimensions of the incandescent filament or another type of increase in the incandescent filament temperature, for example owing to the IR-reflective coating, in principle has an effect on the lamp life. A further optional feature of the invention is thus to increase the filament temperature and in the process to take into account a shortening of the lamp life compared with values for incandescent lamps which are at present conventional. In addition to the abovementioned measures, or even without these measures, it is thus possible to increase the luminous efficiency. Values of at most 900 h, preferably at most 850 h and particularly preferably at most 800 h for average lamp life are preferred. Although this is a statistical value for a group of incandescent lamps, when the incandescent lamp types are designed and tested, the statistical life should be considered to a certain extent to be a technical parameter, i.e. one which is not merely known but can also be controlled.

Although a reduction in the life is in principle considered to be a disadvantage, in conjunction with the desired activating effect it may overall be considered to be an advantage to limit the technical complexity. In principle, the invention should prevent simple filtering from in the end only concentrating the emission spectrum on the activating spectral ranges, without there actually being any real increase therein. Rather, the activating effect should be increased in absolute terms and, overall, a substantially “equally bright” or even brighter incandescent lamp should be produced. This was quantified by the luminous efficiency in the described manner.

In this case, the invention also has the advantage that the lamp not only has a refreshing effect and increases the readiness of the body and the mind to perform, but is also perceived by the user to be fresher in subjective terms. This is dependent on the light which is whiter as a result of the increased blue component or the reduction of the yellow component which is in principle excessive in incandescent lamps. It is thus possible to make vision and in particular reading more contrast-rich and less tiring and to achieve a fresher and more natural color rendering. The original functions of the incandescent lamp are thus not only maintained with the invention but are even improved with an appropriate design. In particular, color temperatures of at least 2800 K and color rendering index values Rₐ of at least 90, preferably 92 and particularly preferably 93 are preferred. The color rendering index is likewise an introduced variable and denotes the measure for the correspondence of the surface color with its appearance and the illumination by means of the corresponding lamp. For this purpose, color shifts are determined on the basis of eight test colors standardized in the German industrial standard DIN 6169, and a corresponding index value is calculated. A theoretical, optimal lamp achieves a value of Rₐ=100.

The abovementioned color filter may have a wide variety of designs, in particular even a separate lamp component or a gaseous addition. However, preferred are color filter properties of the lamp bulb and, if provided, preferably of the lamp envelope owing to coatings, colorations or dopings. In addition to doping the bulb glass with Nd or dyes in the blue range contained in the glass, coatings using pigments are also conceivable. Particularly preferred are color filters which at least contain, inter alia, a coating with cobalt aluminates having a spinel structure.

### BRIEF DESCRIPTION OF THE DRAWINGS

The invention will be explained in more detail below with reference to exemplary embodiments, it being possible for the disclosed individual features also to be pertinent to the invention in other combinations.

FIG. 1 shows a schematic illustration of an incandescent lamp according to the invention.

FIG. 2 shows a schematic illustration of a halogen incandescent lamp according to the invention as a second exemplary embodiment.

FIGS. 3a, b, c show the principle of the invention using three spectral graphs.

### BEST MODE FOR CARRYING OUT THE INVENTION

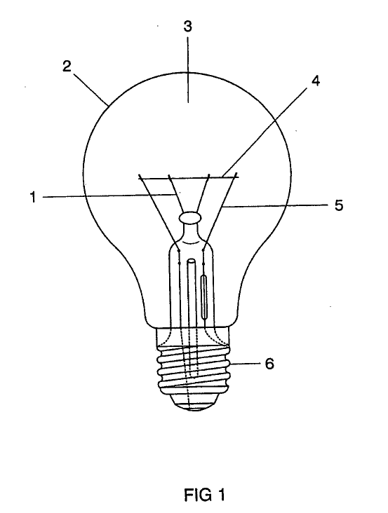

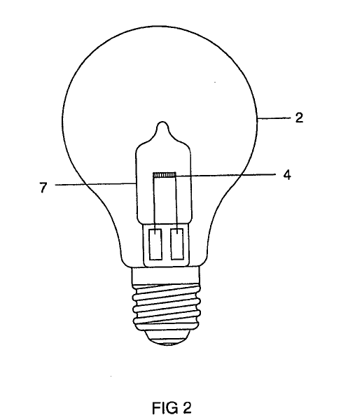

FIG. 1 is an outline illustration of an incandescent lamp according to the invention. The incandescent lamp has an incandescent filament holder 1 and power supply lines 5 within an outer glass bulb 2. A twin-coil filament wire 4, for example, which is held by the incandescent filament holders 1, is stretched in the form of a luminous element between the power supply lines 5. The power supply lines 5 are sealed into the glass in a manner known per se and passed out and connected, within a conventional screw base 6, to the contacts of said screw base 6, as is illustrated in FIG. 1 by dashed lines.

When the incandescent lamp is screwed into a fitting and has voltage applied to it, a current flows through the incandescent filament 4, causes the latter to incandesce and results in a thermal light emission.

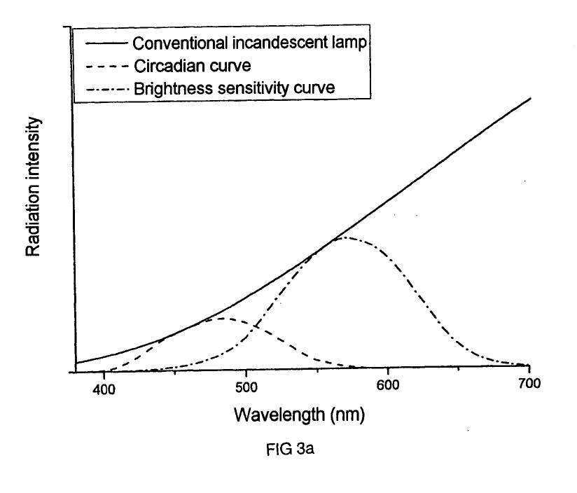

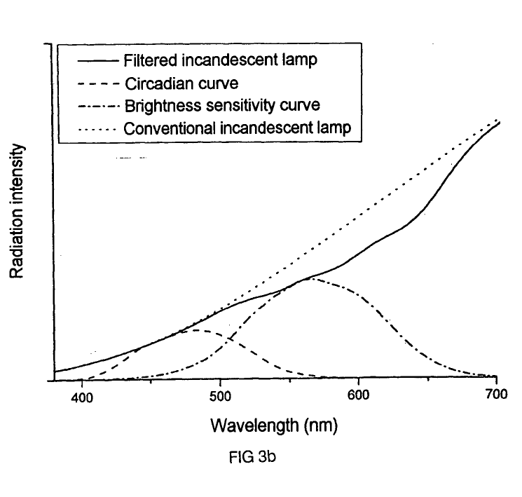

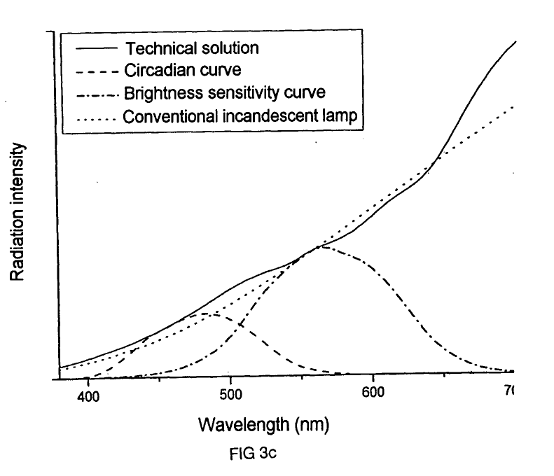

According to the invention, the glass bulb 2 has, in this first exemplary embodiment, an electrostatic powder coating with cobalt aluminate pigments having a spinel structure applied on the inside, which markedly reduces the yellow component of the emitted light. In this exemplary embodiment, 12% by weight cobalt aluminates having a spinel structure are used which are embedded in 88% by weight highly disperse silica powder. For details, reference is made to the explanation for FIG. 3. In the present case, the circadian factor increases in the process by approximately 15% to a value of approximately 0.41 in the case of a 60 W incandescent lamp. Without further measures being taken, however, the luminous efficiency would be significantly reduced, to be precise in this example by approximately 20%.

The incandescent lamp according to the invention therefore also envisages a mixture of 80 vol. % Kr and 20 vol. % of a mixture of 85 vol. % Ar and 15 vol. % N₂ as the gas filling. The filling pressure is 1000 mbar. These measures make it possible to increase the luminous flux in turn by approximately 12%. In addition, the filament temperature is increased to such an extent that the average life expectancy of approximately 1000 h is now reduced to approximately 700 h. This makes it possible to increase the luminous flux by a further 8%, with the result that the luminous flux approximately corresponds to that of an unfiltered, conventional 60 W incandescent lamp. In addition, an IR-reflecting coating of the bulb 2 may optionally be used.

Otherwise, this example uses a conventional incandescent lamp having a so-called A bulb and a so-called E 27 base, designed for an effective operating voltage of 230 V.

The color temperature in this example is 2923 K given a color rendering index of Rₐ=94.

Overall, the circadian factor can thus be increased by approximately 15% whilst the luminous efficiency remains the same.

In the example illustrated, the actual lamp output power was 61.6 W and produced a luminous flux of 655 lm.

Of course, other bulb and base forms are also conceivable.

The incandescent lamp according to the invention thus has a refreshing and activating effect on the human body and can influence the biorhythm. This takes place by means of inhibition of the melatonin formation by an increased light radiation in the region of approximately 450 nm. In addition, the lamp is perceived to be pleasant and comfortable owing to the whiter light which has a fresher effect and owing to the improved color rending.

FIG. 2 shows an alternative example in which the conventional incandescent filament 4 from FIG. 1 has been replaced by a high-volt halogen lamp which is conventional per se. Specifically, in FIG. 2 a high-volt halogen lamp 7 is inserted into the bulb 2 shown in FIG. 1 and has a dedicated small bulb for the purpose of reducing the gas filling volume. The envelope 2 is coated as already explained with reference to FIG. 1. In this case, the luminous efficiency can be increased using halogen technology. In addition, it is naturally also possible for further measures to be taken to increase the luminous efficiency as compared with that of a halogen incandescent lamp, for example at the expense of the life.

Other exemplary embodiments are naturally also conceivable in which, for example, low-volt halogen lamps have a corresponding filtering coating for a lamp or envelope.

In the case of reflector lamps having cover disks set in front it is possible to achieve comparable effects by using special filter disks.

FIGS. 3a, b, c explain the principle of the invention using three spectral graphs a, b and c, in which the radiation intensity of the lamps (in relative units) is plotted in nm as a function of the wavelength of the radiation. The first graph a shows, using the continuous curve, the radiation intensity of a conventional 60 W incandescent lamp which corresponds to the incandescent lamp shown in FIG. 1, apart from the measures according to the invention. This relates to a part of the thermal emission which is in the visible wavelength range. The curve is similar to a section of the Planckian locus for the so-called black body radiator, but the short-wave radiation is increased slightly when tungsten is used as the incandescent filament material.

The dashed curve shows the product of this continuous curve with the relative sensitivity of the blue-sensitive receptors (already mentioned many times) of the human eye which are partly responsible for controlling the melatonin generation. The basic sensitivity curve, as can be seen, lies in the blue spectral range. The maximum sensitivity (100%) corresponds to points at which it comes into contact with the continuous curve. The details are dependent in particular on the light/dark adaptation of the eye and are not explained here specifically. The dashed curve thus only has qualitative significance.

The dash-dotted curve shows the product of the continuous curve with the spectral brightness sensitivity of the human eye, and thus relates to the usual powers of vision. The brightness sensitivity has a maximum of approximately 555 nm, i.e. in the green range. An integral over the dash-dotted curve would give the luminous flux of the lamp.

Graph a thus shows that a conventional incandescent lamp only has small components having a circadian effect and, relative thereto, even relatively large brightness-relevant components, but primarily a pronounced yellow and red range, owing to the typical spectral distribution in the thermal emission.

Graph b shows the curves from graph a, the continuous curve being dotted in this case. The continuous line in graph b corresponds to the incandescent lamp emission following filtering according to the invention. It can be seen that the filtering filters off hardly any spectral power in the range having a circadian effect, but shows a marked filtering effect in the range between 500 and 700 nm. In addition to the in turn relatively lesser filtering effect in the range between 700 and 800 nm, it should be mentioned that there is also the objective of keeping an overall white impression so that there are no faults in the color of the lamp. It can be seen that the dash-dotted curve is lower and the lamp is thus less bright.

Graph c is a qualitative illustration of graph b, but the continuous curve is vertically higher. In this case, the above described compensation of the luminous flux loss has been taken into account. In graph c, the dotted and the continuous lines thus substantially show the same luminous flux and thus essentially the same luminous efficiency (given a lamp output power which has remained the same). In other words: the integral of the dash-dotted curve over the visible range is approximately the same in both cases. The incandescent lamp according to the invention shown in FIG. 1 corresponds to this continuous line. The dashed line which is higher in this case in comparison with graphs a and b shows that, as a result, the circadian spectral range has increased in absolute terms.

1. An incandescent lamp which is designed such that it achieves a minimum luminous efficiency, listed below, dependent on the lamp output power:

| Lamp output powers/W | Luminous efficiency/lm/W |
|---|---|
| 5-20 | 5.7 |
| 20-33 | 7.2 |
| 33-50 | 9.2 |
| 50-68 | 10.1 |
| 68-88 | 11.8 |
| 88-125 | 12.6 |
| 125-175 | 13.5 |
| 175-250 | 14.2 |
| 250-400 | 14.4 |
| ≧400 | 15.8 |

and which is characterized by a color filter for filtering the incandescent lamp light and for increasing the circadian factor to at least 0.38.

2. The incandescent lamp as claimed in claim 1, in which an envelope of the incandescent lamp acts as the color filter, in particular by means of an envelope coating.

3. The incandescent lamp as claimed in claim 2 having an envelope coating which has Co aluminates having a spinel structure.

4. The incandescent lamp as claimed in claim 1 having an atmosphere which surrounds an incandescent filament of the incandescent lamp and has Ar, N₂, Kr and/or Xe in the filling gas.

5. The incandescent lamp as claimed in claim 4, in which the gas atmosphere surrounding the incandescent filament contains 60-97 vol. % Kr, 0-37 vol. % Ar and 3-40 vol. % N₂.

6. The incandescent lamp as claimed in claim 4 having a filling pressure of at least 850 mbar.

7. The incandescent lamp as claim 1 having an atmosphere which surrounds an incandescent filament of the incandescent lamp and includes a halogen additive.

8. The incandescent lamp as claim 1 having an IR-reflective coating for the purpose of reflecting IR radiation emitted by an incandescent filament of the incandescent lamp.

9. The incandescent lamp as claim 1 also in combination with claim 8, whose statistical average life is at most 900 h.

10. The incandescent lamp as claim 1 having a color temperature of the radiated light of at least 2900 K.

11. The incandescent lamp as claim 1 having a color rendering index Rₐ of at least 90.

12. The incandescent lamp as claimed in claim 5 having a filling pressure of at least 850 mbar.

13. The incandescent lamp as claimed in claim 2 having an atmosphere which surrounds an incandescent filament of the incandescent lamp and includes a halogen additive.

14. The incandescent lamp as claimed in claim 3 having an atmosphere which surrounds an incandescent filament of the incandescent lamp and includes a halogen additive.
